(19) United States
(12) Patent Application Publication
(10) Pub. No.: US 2025/0066213 A1
(43) Pub. Date: Feb. 27, 2025

(54) CARBON DIOXIDE MINERALIZATION AND STORAGE

(71) Applicant: SAUDI ARABIAN OIL COMPANY, Dhahran (SA)

(72) Inventors: Pramod Dhanaji PATIL, Dhahran (SA); Abdulaziz S. QASIM, Dhahran (SA); Subhash AYIRALA, Dhahran (SA); Ali A. YOUSEF, Dhahran (SA)

(73) Assignee: SAUDI ARABIAN OIL COMPANY, Dhahran (SA)

(21) Appl. No.: 18/456,201

(22) Filed: Aug. 25, 2023

(51) Int. Cl. C01B 32/55; B01J 23/755; B01J 35/00; B01J 35/02; C01F 5/24; C01F 11/18

(52) U.S. Cl. CPC C01F 11/182; B01J 23/755; B01J 35/23; B01J 35/40; C01F 5/24; C01F 11/181; E21B 43/164

(57) ABSTRACT

Carbon dioxide may be stored by mineralization. An example method thereof may include: providing a first solution including a first aqueous fluid having dispersed therein a metal salt and a metal catalyst; dispersing carbon dioxide gas in a second solution including a second aqueous fluid, wherein the carbon dioxide gas forms dissolved carbon dioxide; introducing an electrical current to the second solution; generating, using the electrical current, nanobubble carbon dioxide; combining at least a portion of the first solution and at least a portion of the second solution to form a combined solution; and generating mineralized carbon dioxide from the dissolved carbon dioxide and the nanobubble carbon dioxide, wherein the generating at least partially comprises catalytically reacting, using the metal catalyst, the metal salt and one or more of the dissolved carbon dioxide and the nanobubble carbon dioxide, thereby forming the mineralized carbon dioxide.

### FIELD OF THE DISCLOSURE

The present disclosure relates generally to carbon dioxide sequestration and, more particularly, to mineralization and storage of carbon dioxide.

### BACKGROUND OF THE DISCLOSURE

Reducing greenhouse gas emissions such as those of carbon dioxide are included in many energy transition plans. In particular, carbon capture, utilization, and storage (CCUS) is believed to be a promising technology area for reducing greenhouse gas emissions. As global populations continue to rise, use of fossil-fuels will continue for purposes including heating and cooling, power generation, transport, and industry. CCUS offers emission reduction technology that may be applied across the energy system. CCUS technologies allow for the capture of carbon dioxide (CO₂) from fuel combustion or other industrial processes, transportation of the CO₂, and use of the CO₂ either through a storage means (e.g., in subterranean geological formations) or as a resource to create products or services (e.g., for industrial uses).

Carbon dioxide mineralization is a form of CCUS whereby CO₂ is chemically converted to a mineral, often a carbonate compound. Mineralization of CO₂ allows for stable storage and/or processing of carbonate product for industrial use.

### SUMMARY OF THE DISCLOSURE

Various details of the present disclosure are hereinafter summarized to provide a basic understanding. This summary is not an exhaustive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

A first nonlimiting example method of the present disclosure includes: providing a first solution comprising a first aqueous fluid having dispersed therein a metal salt and a metal catalyst; dispersing carbon dioxide gas in a second solution comprising a second aqueous fluid, wherein the carbon dioxide gas forms dissolved carbon dioxide; introducing an electrical current to the second solution; generating, using the electrical current, nanobubble carbon dioxide from the carbon dioxide gas and/or the dissolved carbon dioxide in the second solution; combining at least a portion of the first solution and at least a portion of the second solution to form a combined solution; and generating mineralized carbon dioxide from the dissolved carbon dioxide and the nanobubble carbon dioxide, wherein the generating at least partially comprises catalytically reacting, using the metal catalyst, the metal salt, and one or more of the dissolved carbon dioxide and the nanobubble carbon dioxide, thereby forming the mineralized carbon dioxide.

A second nonlimiting example method of the present disclosure includes: providing a first solution comprising a first aqueous fluid having dispersed therein a metal salt and a metal catalyst; dispersing carbon dioxide gas in a second solution comprising a second aqueous fluid, wherein the carbon dioxide gas forms dissolved carbon dioxide; introducing an electrical current to the second solution; generating, using the electrical current, nanobubble carbon dioxide from the carbon dioxide gas and/or the dissolved carbon dioxide in the second solution; combining at least a portion of the first solution and at least a portion of the second solution to form a combined solution; generating mineralized carbon dioxide from the dissolved carbon dioxide and the nanobubble carbon dioxide, wherein the generating at least partially comprises catalytically reacting, using the metal catalyst, the metal salt, and one or more of the dissolved carbon dioxide and the nanobubble carbon dioxide, thereby forming the mineralized carbon dioxide; separating the mineralized carbon dioxide from the combined solution; separating the metal catalyst from the combined solution; wherein the combined solution forms a regenerated solution after separation; and introducing the regenerated solution to a subterranean formation during a reservoir stimulation operation.

A nonlimiting example system of the present disclosure includes: a first tank having therein a first solution comprising a first aqueous fluid, a metal salt, and a metal catalyst, wherein the metal salt and the metal catalyst are dispersed in the first solution; a second tank, fluidly connected to the first tank by a first conduit, having therein a second solution comprising a second aqueous fluid and dissolved carbon dioxide; an electrical current generator within the second tank, wherein the electrical current generator induces an electrical current, generating nanobubble carbon dioxide from the dissolved carbon dioxide; and a combined solution in the second tank formed from the first solution and the second solution, wherein the combined solution comprises mineralized carbon dioxide dispersed therein, the mineralized carbon dioxide formed from reaction of nanobubble carbon dioxide with the metal salt in the presence of the metal catalyst and/or reaction of dissolved carbon dioxide with the metal salt in the presence of the metal catalyst.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a diagram of a nonlimiting example system according to the present disclosure.

FIG. 2 is a diagram of a nonlimiting example system according to the present disclosure.

FIG. 3 is a diagram of a nonlimiting example system according to the present disclosure.

### DETAILED DESCRIPTION

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to carbon dioxide sequestration and, more particularly, to mineralization and storage of carbon dioxide.

The present disclosure provides methods and systems for carbon dioxide sequestration through mineralization and dissolution of carbon dioxide through use of aqueous solutions. The present disclosure may allow for increased mineralization of carbon dioxide up to 30% greater than conventional mineralization methods and systems due to added mineralization of carbon dioxide nanobubbles.

The present disclosure may utilize two solutions such that a first solution includes a metal salt and a catalyst and a second solution includes carbon dioxide in a form of dissolved carbon dioxide and nanobubble carbon dioxide. The generation of nanobubble carbon dioxide in combination with dissolved carbon dioxide may allow for an greater quantity of carbon dioxide to be dispersed within the second solution and subsequently mineralized. The first solution and second solution may be combined, thus reacting the metal salt with the carbon dioxide in the presence of a catalyst, forming mineralized carbon dioxide. The combined solution may subsequently be processed and the catalyst, mineralized carbon dioxide, and remaining solution may each be further used in a commercial application or recycled internally within the presently described process.

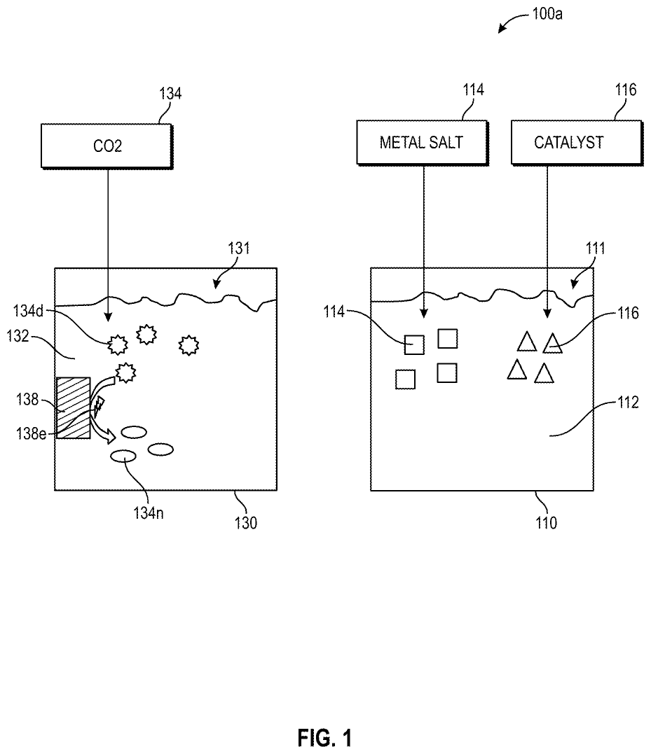

A nonlimiting example system of the present disclosure is shown in FIG. 1. System 100a may include a first tank 110 and a second tank 130. First tank 110 may have therein a first solution 111 comprising a first aqueous fluid 112, the first aqueous fluid 112 having dispersed therein metal salt 114 and catalyst 116, the metal salt 114 at least partially dissolved in the first aqueous fluid 112. It should be noted that metal salt 114 and/or catalyst 116 may be added to first aqueous fluid 112 already within first tank 110. Second tank 130 may have therein a second solution 131 comprising a second aqueous fluid 132, the second aqueous fluid 132 having dispersed therein carbon dioxide 134. The carbon dioxide 134 may be added to the second solution 131. Second solution 131 may contain therein carbon dioxide 134 in the form of dissolved carbon dioxide 134d and/or nanobubble carbon dioxide 134n. Second tank 130 may have therein an electrical current generator 138 for generating electrical current 138e such that electrical current 138e promotes the formation of nanobubble carbon dioxide 134n from dissolved carbon dioxide 134d.

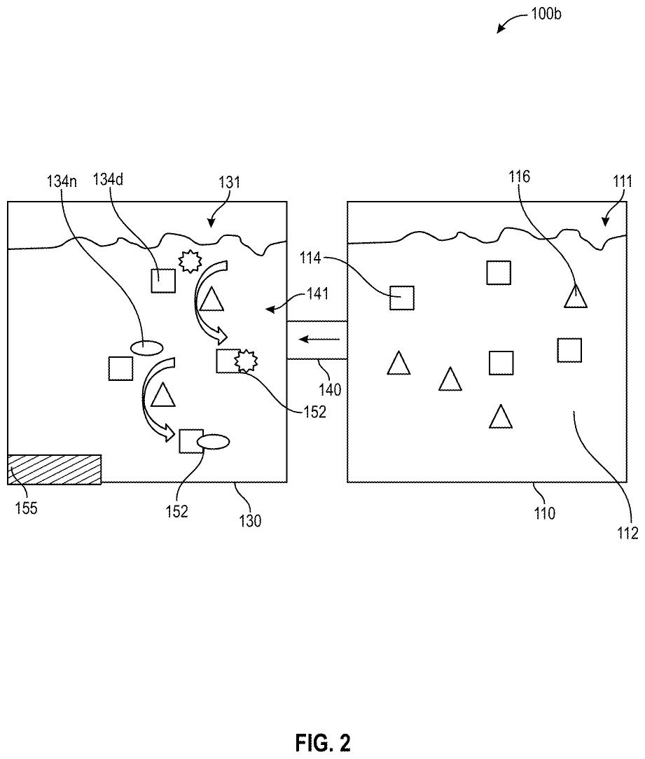

A second nonlimiting example system 100b of the present disclosure is shown in FIG. 2, with continued reference to FIG. 1. It should be noted that in the interest of brevity, previously described reference characters may be omitted from further descriptions of subsequent figures. System 100b includes a first conduit 140 for introducing the first solution 111 from first tank 110 to second tank 130, thus combining first solution 111 and second solution 131 to form a combined solution 141. The nanobubble carbon dioxide 134n and the dissolved carbon dioxide 134d may each react with the metal salt 114 in the presence of catalyst 116, generating mineralized carbon dioxide 152. Mineralized carbon dioxide 152 may be dispersed within combined solution 141. Furthermore, the reaction to form mineralized carbon dioxide 152 in the presence of catalyst 116 may produce energy to be captured by energy capture device 155.

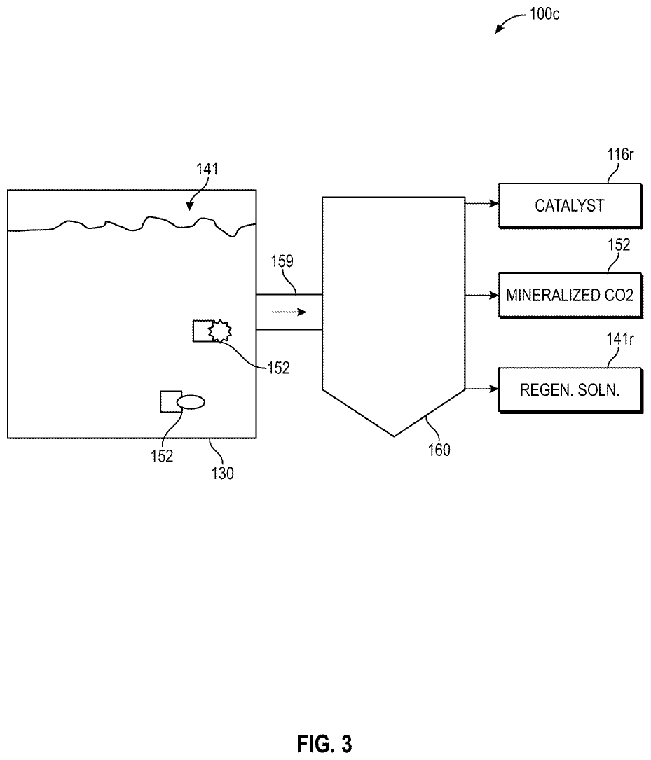

A third nonlimiting example system 100c of the present disclosure is shown in FIG. 3, with continued reference to FIGS. 1 and 2. System 100c may include wherein combined solution 141 is transferred from second tank 130 via second conduit 159 to a separator 160. Separator 160 may separate the combined solution 141 to form regenerated catalyst 116r, mineralized carbon dioxide 152, and regenerated solution 141r.

It should be noted that any systems described herein may be combined together in whole or in part in accordance with the present disclosure. Such combined configurations may include, but are not limited to a system including 100a, 100b, and 100c.

The first tank may be of any suitable size, shape, and material for formation of the first solution according to the present disclosure. The first tank may be at any suitable temperature and pressure during formation of the first solution including ambient temperature and pressure or, for example, including, but not limited to, a temperature of −5° C. to 45° C. and a pressure of 0.1 atma (atmospheres, absolute) to 5 atma, or about 1 atma. The first solution may comprise a first aqueous fluid, a metal salt, and a catalyst. Optionally, the first solution may further comprise fly ash. The first aqueous fluid may comprise a brine (e.g., seawater, waste water brine from desalination, produced water, formation water, the like, or any combination thereof). The brine used in the first aqueous fluid may have a total dissolved solids content (TDS) from 100 ppm to 250,000 ppm (or 100 ppm to 100,000 ppm, or 1,000 ppm to 250,000 ppm), prior to addition of catalyst, metal salt, and optional fly ash.

The metal salt may comprise any suitable metal salt including, but not limited to, for example, a metal hydroxide salt (e.g., calcium hydroxide (Ca(OH)₂), magnesium hydroxide (Mg(OH)₂), sodium hydroxide (Na(OH)₂), the like, or any combination thereof), a chloride salt (e.g., sodium chloride (NaCl), potassium chloride (KCl), magnesium chloride (MgCl), the like, or any combination thereof), the like, or any combination thereof. It should be noted that a portion of the metal salt may be supplied by the aqueous fluid (e.g., brine) used in the first solution and/or a portion of the metal salt may be added to the aqueous fluid to form the first solution. The metal salt may have a final concentration in the first solution of 0.5 wt % to 35 wt %, or 1 wt % to 30 wt %, or 1 wt % to 20 wt %, or 10 wt % to 30 wt %, or 30 wt % or less (by weight of the first solution). The metal salt may be at least partially dissolved in the first aqueous fluid.

The catalyst may comprise a metal catalyst (e.g., a nickel catalyst, a cobalt catalyst, a zinc catalyst, a molybdenum catalyst, a platinum catalyst, a palladium catalyst, a rhodium catalyst, an iron catalyst, the like, or any combination thereof). The catalyst may preferably comprise a nickel catalyst. The catalyst may be dispersed within the first solution. The catalyst may comprise particles of any suitable size. The catalyst may preferably comprise nanoparticles. “Nanoparticle,” and grammatical variations thereof, as used herein, refers to a particle having average dimension(s) on the scale of 0.1 nanometers (nm) to 10,000 nm, preferably 0.1 nm to 1000 nm, and more preferably 0.1 nm to 100 nm. Catalyst concentration in the first solution may be 1 ppm to 10,000 ppm, preferably 10 ppm to 500 ppm, more preferably 10 ppm to 100 ppm.

The optional fly ash may be included in the first solution at any suitable concentration including a concentration of 0.1 wt % to 20 wt %, or 0.1 wt % to 15 wt %, or 1 wt % to 10 wt %. Any suitable type of fly ash may be used, including, but not limited to, fly ash originating from bituminous coal, subbituminous coal, lignite, the like, or any combination thereof.

The second tank may be of any suitable size, shape, and material for formation of the second solution according to the present disclosure. The second tank may be at a temperature and pressure of 500 psig to 10,000 psig (or 1,000 psig to 9,000 psig, or 2,000 psig to 6,000 psig, or 4,000 psig to 6,000 psig, or about 5,000 psig) during introduction of carbon dioxide to the second solution. The second solution may comprise the second aqueous fluid and carbon dioxide. The second aqueous fluid may comprise any suitable aqueous fluid including, but not limited to, for example, water, freshwater, seawater, waste water (e.g., brine from desalination, produced water, formation water, the like, or any combination thereof), the like, or any combination thereof.

Carbon dioxide may be added to the second tank at any suitable pressure, preferably a pressure sufficient to introduce the carbon dioxide to the second solution. The carbon dioxide may be added to the second tank at any suitable flow rate. The flow rate may be determined by the size of the second tank. Carbon dioxide may be added in a quantity at or greater than the saturation limit of carbon dioxide gas in the second solution, such that the second solution is oversaturated. The carbon dioxide may be added in a quantity that is from 1 vol % to 25 vol % (or 1 vol % to 15 vol %, or 5 vol % to 15 vol %, or about 10 vol %) over the saturation limit. “Saturation limit,” “saturated,” and grammatical variations thereof, as used herein refers to wherein a solution has absorbed a maximum amount of a solute at given temperature and pressure conditions. “Oversaturated” as used herein refers to a solution that contains more solute than the maximum saturated amount, wherein the additional solute beyond the maximum saturated amount cannot be absorbed in the solution at given temperature and pressure conditions.

The carbon dioxide may form dissolved carbon dioxide and/or nanobubble carbon dioxide. Furthermore, nanobubble carbon dioxide generation from the carbon dioxide (including the dissolved carbon dioxide) may be promoted due to electrical stimulation of the second solution.

The electrical stimulation of the second solution may be performed by any suitable electrical current generator. In some embodiments, the electrical current generator may comprise an electrostriction apparatus (or “electrostrictor”) based on electrostriction. “Electrostriction” as used herein refers to a property of electrical non-conductor materials, or dielectric materials, to undergo shape change upon application of an electric field. Electrostriction of an aqueous fluid may, without being bound by theory, displace ions by reducing water availability for interaction with such ions, thereby promoting the formation of nanobubble carbon dioxide.

The electrical current generator may operate at any suitable current and voltage, and may utilize direct current and/or alternating current. As a nonlimiting example, an electrical current generator may have a voltage of 0.01 volts (V) to 100 V, or 0.01 V to 10 V; and as a further nonlimiting example, an electrical current generator may have a current of 0.1 amps (A) to 50 A, or 0.1 to 25 A. The electrical current generator may have an anode and a cathode. Said anode and said cathode may be of any suitable material capable of effectively conducting electricity so as to convey current through solutions in which the cathode and anode are immersed. Such material should be compatible with solutions of the present disclosure. Example cathode and anode materials may include, but are not to be limited to, for example, a metal (e.g., steel, titanium, the like, or any combination thereof), a carbon-fiber compound, the like, or any combination thereof. One of ordinary skill in the art will be able to implement appropriate apparatus for electrical stimulation with the benefit of the present disclosure.

“Nanobubble,” and grammatical variations thereof, as used herein, refers to bubbles having average dimension(s) on the scale of 0.1 nanometers (nm) to 10,000 nm, preferably 0.1 nm to 1000 nm, and more preferably 0.1 nm to 100 nm. The nanobubble carbon dioxide may become dispersed within the second solution.

The first solution and the second solution may be combined in any suitable fashion, thus forming a combined solution. As a nonlimiting example, the first solution may be introduced into the second solution through a conduit, thus forming a combined solution. In the combined solution, nanobubble carbon dioxide and dissolved carbon dioxide may each be converted to mineralized carbon dioxide through catalytic interaction with metal salt. Without being bound by theory, nonlimiting example reactions are shown in Equations 1 and 2 below.

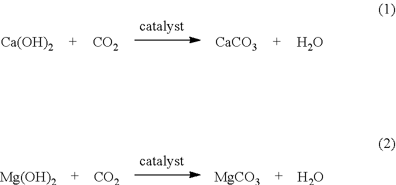

where calcium hydroxide and magnesium hydroxide each serve as metal salts, producing mineralized carbon dioxide in the form of calcium carbonate and magnesium carbonate, respectively, upon catalytic reaction with carbon dioxide.

The mineralizing of carbon dioxide may occur at a temperature of 20° C. to 300° C., or 20° C. to 250° C., or preferably 20° C. to 100° C., or more preferably 20° C. to 60° C. Mineralizing of carbon dioxide may occur at a pressure of 50 psig to 5000 psig, preferably 50 psig to 2000 psig, or more preferably 50 psig to 1300 psig.

The reaction of carbon dioxide and the metal salt may be exothermic and thus provide energy generation. The second tank may optionally include a means of capturing energy generated by the reaction through an energy capture device including, but not limited to, for example, a heat exchanger, a thermoelectric generator, the like, or any combination thereof.

The combined solution including the mineralized carbon dioxide, catalyst, and combined solution may be passed through a separator to separate materials dispersed within the combined solution. Suitable separators may include a hydrocyclone separator, a filter, or any combination thereof. The mineralized carbon dioxide may subsequently be dried and further processed to form a mineralized carbon powder for commercial sale and use, allowing for production of a value added product. Drying of the mineralized carbon dioxide to form mineralized carbon powder may use any suitable apparatus including, but not limited to, a dryer, an oven, the like, or any combination thereof. The separation of combined solution using the separator may form regenerated solution therefrom. The regenerated solution may optionally be further processed using any suitable means. Furthermore, the regenerated solution may be recycled to form the first solution, the second solution, or both. The regenerated solution may be introduced to a subterranean formation during a reservoir stimulation operation (e.g., hydraulic fracturing, aqueous fluid injection, the like, or any combination thereof). One of ordinary skill in the art will be able to formulate a fluid for use in a reservoir stimulation operation utilizing the regenerated solution with the benefit of the present disclosure.

It should be noted that the present disclosure may include methods of mineralizing carbon dioxide as described above, including wherein said methods employ systems previously described. Such methods may include providing a first solution, providing a second solution, and dispersing carbon dioxide gas in the second solution. Such methods may further include introducing electrical stimulation in the form of an electrical current to the second solution and subsequently generating nanobubble carbon dioxide. Methods may further include combining at least a portion of the first solution and at least a portion of the second solution to form a combined solution, and generating mineralized carbon dioxide from the combined solution.

Furthermore, it should be noted that within the present disclosure any suitable method/system of combining a first solution and a second solution may be utilized (e.g., a second solution may be transferred to a first tank to combine with a first solution or the first solution and second solution may both be transferred to a third tank for mineralization). Additionally, other suitable configurations of carbon dioxide mineralization tanks may be used in accordance with the present disclosure. Furthermore, methods of the present disclosure may include operation of mineralization in any suitable manner, including any suitable operational fashion (e.g., a continuous fashion, a batch-wise fashion, the like, or a combination thereof).

For the purpose of these simplified schematic illustrations and description, there may be additional valves, lines, pumps, sensors, controllers, wires, and the like that are customarily employed in carbon sequestration operations that are well known to those of ordinary skill in the art that are not shown.

### Additional Embodiments

Embodiments disclosed herein include:

Embodiment 1. A method comprising: providing a first solution comprising a first aqueous fluid having dispersed therein a metal salt and a metal catalyst; dispersing carbon dioxide gas in a second solution comprising a second aqueous fluid, wherein the carbon dioxide gas forms dissolved carbon dioxide; introducing an electrical current to the second solution; generating, using the electrical current, nanobubble carbon dioxide from the carbon dioxide gas and/or the dissolved carbon dioxide in the second solution; combining at least a portion of the first solution and at least a portion of the second solution to form a combined solution; and generating mineralized carbon dioxide from the dissolved carbon dioxide and the nanobubble carbon dioxide, wherein the generating at least partially comprises catalytically reacting, using the metal catalyst, the metal salt, and one or more of the dissolved carbon dioxide and the nanobubble carbon dioxide, thereby forming the mineralized carbon dioxide.

Embodiment 2. The method of Embodiment 1, wherein the first aqueous fluid comprises brine, and wherein the brine has total dissolved solids of 100 parts per million (ppm) to 250,000 ppm.

Embodiment 3. The method of Embodiment 1 or 2, wherein the metal salt comprises calcium hydroxide, magnesium hydroxide, sodium chloride, sodium hydroxide, or any combination thereof.

Embodiment 4. The method of any one of Embodiments 1-3, wherein the first solution further comprises fly ash.

Embodiment 5. The method of any one of Embodiments 1-4, wherein the metal catalyst comprises nickel, wherein the nickel comprises nanoparticles, and wherein the nanoparticles have a size of 0.1 nanometers (nm) to 10,000 nm.

Embodiment 6. The method of any one of Embodiments 1-5, wherein the metal salt has a concentration in the first solution of 30 wt % or less, by weight of the first solution.

Embodiment 7. The method of any one of Embodiments 1-6, wherein the second solution is oversaturated with the dissolved carbon dioxide.

Embodiment 8. The method of any one of Embodiments 1-7, wherein the mineralized carbon dioxide comprises a carbonate compound.

Embodiment 9. The method of Embodiment 8, wherein the carbonate compound comprises calcium carbonate, magnesium carbonate, sodium bicarbonate, or any combination thereof.

Embodiment 10. The method of any one of Embodiments 1-9, further comprising: a) separating the mineralized carbon dioxide from the combined solution; b) separating the metal catalyst from the combined solution; or c) a and b; wherein the combined solution forms a regenerated solution after separation.

Embodiment 11. The method of Embodiment 10, wherein a) the separating comprises flowing the combined solution through a cyclonic separator; b) the separating comprises filtering the combined solution; or c) a and b.

Embodiment 12. The method of Embodiment 10 or 11, further comprising drying the mineralized carbon dioxide obtained from separation to form a mineralized carbon powder.

Embodiment 13. The method of any one of Embodiments 1-12, further comprising recycling at least a portion of the regenerated solution to form the first solution, the second solution, or both.

Embodiment 14. The method of any one of Embodiments 1-13, further comprising introducing the regenerated solution to a subterranean formation during a reservoir stimulation operation.

Embodiment 15. The method of Embodiment 14, wherein the reservoir stimulation operation comprises hydraulic fracturing, aqueous fluid injection, or any combination thereof.

Embodiment 16. The method of any one of Embodiments 1-15, further comprising maintaining the combined solution at a temperature from 20° C. to 250° C. during the generation of mineralized carbon dioxide.

Embodiment 17. A method comprising: providing a first solution comprising a first aqueous fluid having dispersed therein a metal salt and a metal catalyst; dispersing carbon dioxide gas in a second solution comprising a second aqueous fluid, wherein the carbon dioxide gas forms dissolved carbon dioxide; introducing an electrical current to the second solution; generating, using the electrical current, nanobubble carbon dioxide from the carbon dioxide gas and/or the dissolved carbon dioxide in the second solution; and combining at least a portion of the first solution and at least a portion of the second solution to form a combined solution; generating mineralized carbon dioxide from the dissolved carbon dioxide and the nanobubble carbon dioxide, wherein the generating at least partially comprises catalytically reacting, using the metal catalyst, the metal salt and one or more of the dissolved carbon dioxide and the nanobubble carbon dioxide, thereby forming the mineralized carbon dioxide; separating the mineralized carbon dioxide from the combined solution; separating the metal catalyst from the combined solution; wherein the combined solution forms a regenerated solution after separation; and introducing the regenerated solution to a subterranean formation during a reservoir stimulation operation.

Embodiment 18. A system comprising: a first tank having therein a first solution comprising a first aqueous fluid, a metal salt, and a metal catalyst, wherein the metal salt and the metal catalyst are dispersed in the first solution; a second tank, fluidly connected to the first tank by a first conduit, having therein a second solution comprising a second aqueous fluid and dissolved carbon dioxide; an electrical current generator within the second tank, wherein the electrical current generator induces an electrical current, generating nanobubble carbon dioxide from the dissolved carbon dioxide; and a combined solution in the second tank formed from the first solution and the second solution, wherein the combined solution comprises mineralized carbon dioxide dispersed therein, the mineralized carbon dioxide formed from reaction of nanobubble carbon dioxide with the metal salt in the presence of the metal catalyst and/or reaction of dissolved carbon dioxide with the metal salt in the presence of the metal catalyst.

Embodiment 19. The system of Embodiment 18, further comprising an energy capture device within the second tank.

Embodiment 20. The system of Embodiment 18 or 19, further comprising: a separator fluidly connected to the second tank via a second conduit, wherein the separator separates components of the combined solution to form a regenerated catalyst, mineralized carbon dioxide, and regenerated solution.

Embodiment 21. The method of any one of Embodiments 18-20, wherein the metal salt comprises calcium hydroxide, magnesium hydroxide, sodium hydroxide, sodium chloride, or any combination thereof.

Embodiment 22. The method of any one of Embodiments 18-21, wherein the metal catalyst comprises nickel, wherein the nickel comprises nanoparticles, and wherein the nanoparticles have a size of 0.1 nanometers (nm) to 10,000 nm.

Embodiment 23. The method of any one of Embodiments 18-22, wherein the mineralized carbon dioxide comprises calcium carbonate, magnesium carbonate, sodium bicarbonate, or any combination thereof.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation used herein are merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third, etc.) is for distinction and not counting. For example, the use of “third” does not imply there must be a corresponding “first” or “second.” Also, if used herein, the terms “coupled” or “coupled to” or “connected” or “connected to” or “attached” or “attached to” may indicate establishing either a direct or indirect connection, and is not limited to either unless expressly referenced as such.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A method comprising:
providing a first solution comprising a first aqueous fluid having dispersed therein a metal salt and a metal catalyst;
dispersing carbon dioxide gas in a second solution comprising a second aqueous fluid, wherein the carbon dioxide gas forms dissolved carbon dioxide;
introducing an electrical current to the second solution;
generating, using the electrical current, nanobubble carbon dioxide from the carbon dioxide gas and/or the dissolved carbon dioxide in the second solution;
combining at least a portion of the first solution and at least a portion of the second solution to form a combined solution; and
generating mineralized carbon dioxide from the dissolved carbon dioxide and the nanobubble carbon dioxide, wherein the generating at least partially comprises catalytically reacting, using the metal catalyst, the metal salt, and one or more of the dissolved carbon dioxide and the nanobubble carbon dioxide, thereby forming the mineralized carbon dioxide.

2. The method of claim 1, wherein the first aqueous fluid comprises brine, and wherein the brine has total dissolved solids of 100 parts per million (ppm) to 250,000 ppm.

3. The method of claim 1, wherein the metal salt comprises calcium hydroxide, magnesium hydroxide, sodium chloride, sodium hydroxide, or any combination thereof.

4. The method of claim 1, wherein the first solution further comprises fly ash.

5. The method of claim 1, wherein the metal catalyst comprises nickel, wherein the nickel comprises nanoparticles, and wherein the nanoparticles have a size of 0.1 nanometers (nm) to 10,000 nm.

6. The method of claim 1, wherein the metal salt has a concentration in the first solution of 30 wt % or less, by weight of the first solution.

7. The method of claim 1, wherein the second solution is oversaturated with the dissolved carbon dioxide.

8. The method of claim 1, wherein the mineralized carbon dioxide comprises a carbonate compound.

9. The method of claim 8, wherein the carbonate compound comprises calcium carbonate, magnesium carbonate, sodium bicarbonate, or any combination thereof.

10. The method of claim 1, further comprising:
a) separating the mineralized carbon dioxide from the combined solution;
b) separating the metal catalyst from the combined solution; or
c) a and b;
wherein the combined solution forms a regenerated solution after separation.

11. The method of claim 10, wherein
a) the separating comprises flowing the combined solution through a cyclonic separator;
b) the separating comprises filtering the combined solution; or
c) a and b.

12. The method of claim 10, further comprising drying the mineralized carbon dioxide obtained from separation to form a mineralized carbon powder.

13. The method of claim 10, further comprising recycling at least a portion of the regenerated solution to form the first solution, the second solution, or both.

14. The method of claim 10, further comprising introducing the regenerated solution to a subterranean formation during a reservoir stimulation operation.

15. The method of claim 14, wherein the reservoir stimulation operation comprises hydraulic fracturing, aqueous fluid injection, or any combination thereof.

16. The method of claim 1, further comprising maintaining the combined solution at a temperature from 20° C. to 250° C. during the generation of mineralized carbon dioxide.

17. A method comprising:
providing a first solution comprising a first aqueous fluid having dispersed therein a metal salt and a metal catalyst;
dispersing carbon dioxide gas in a second solution comprising a second aqueous fluid, wherein the carbon dioxide gas forms dissolved carbon dioxide;
introducing an electrical current to the second solution;
generating, using the electrical current, nanobubble carbon dioxide from the carbon dioxide gas and/or the dissolved carbon dioxide in the second solution;
combining at least a portion of the first solution and at least a portion of the second solution to form a combined solution;
generating mineralized carbon dioxide from the dissolved carbon dioxide and the nanobubble carbon dioxide, wherein the generating at least partially comprises catalytically reacting, using the metal catalyst, the metal salt and one or more of the dissolved carbon dioxide and the nanobubble carbon dioxide, forming the mineralized carbon dioxide;
separating the mineralized carbon dioxide from the combined solution;
separating the metal catalyst from the combined solution;
wherein the combined solution forms a regenerated solution after separation; and
introducing the regenerated solution to a subterranean formation during a reservoir stimulation operation.

18. A system comprising:
a first tank having therein a first solution comprising a first aqueous fluid, a metal salt, and a metal catalyst, wherein the metal salt and the metal catalyst are dispersed in the first solution;
a second tank, fluidly connected to the first tank by a first conduit, having therein a second solution comprising a second aqueous fluid and dissolved carbon dioxide;
an electrical current generator within the second tank, wherein the electrical current generator induces an electrical current, generating nanobubble carbon dioxide from the dissolved carbon dioxide; and
a combined solution in the second tank formed from the first solution and the second solution, wherein the combined solution comprises mineralized carbon dioxide dispersed therein, the mineralized carbon dioxide formed from reaction of nanobubble carbon dioxide with the metal salt in the presence of the metal catalyst and/or reaction of dissolved carbon dioxide with the metal salt in the presence of the metal catalyst.

19. The system of claim 18, further comprising:
a separator fluidly connected to the second tank via a second conduit, wherein the separator separates components of the combined solution to form a regenerated catalyst, mineralized carbon dioxide, and regenerated solution.

20. The method of claim 18, wherein the metal salt comprises calcium hydroxide, magnesium hydroxide, sodium hydroxide, sodium chloride, or any combination thereof.
